(19) United States
(12) Patent Application Publication
(10) Pub. No.: US 2006/0053264 A1
(43) Pub. Date: Mar. 9, 2006

(54) Semiconductor device preventing writing of prohibited set value to register

(75) Inventor: Akira Miho, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/064,081

(22) Filed: Feb. 24, 2005

(30) Foreign Application Priority Data
Sep. 6, 2004 (JP) 2004-258906

(51) Int. Cl. G06F 12/14

(52) U.S. Cl. 711/163

(57) ABSTRACT

A semiconductor device includes a data hold circuit configured to acquire data from a data bus and hold the data therein in response to assertion of a write signal, a prohibited set value hold circuit configured to store a predetermined prohibited set value, and a comparison circuit coupled to the data hold circuit and the prohibited set value hold circuit, and configured to assert a prohibition signal in response to a match between the prohibited set value stored in the prohibited set value hold circuit and the data held in the data hold circuit, the assertion of the prohibition signal preventing the data from being written to a predetermined register.

### CROSS-REFERENCE TO RELATED APPLICATIONS

The present application is based upon and claims the benefit of priority from the prior Japanese Patent Application No. 2004-258906 filed on Sep. 6, 2004, with the Japanese Patent Office, the entire contents of which are incorporated herein by reference.

### BACKGROUND OF THE INVENTION

1. Field of the Invention

The present invention generally relates to methods of controlling semiconductor devices and data writing, and particularly relates to a method of controlling a semiconductor device provided with a circuit for controlling a data setting to a register and a method of controlling data writing to a register.

2. Description of the Related Art

In semiconductor chips, a CPU and various resources are provided as circuits implemented by use of semiconductors. The semiconductor circuits such as the CPU and resources are provided with one or more registers for the purpose of defining operation modes. Desired settings are made to control the operations. If users set prohibited set values to the registers, or if the prohibited set values are accidentally set due to noise, for example, the semiconductor circuits malfunction, which may result in the loss of control of chip operations.

The resource circuits include a clock generation circuit, a timer circuit, an A/D converter, a communication macro, etc. In a resource circuit such as a communication macro that operates in synchronization with a clock, the range of the clock for providing proper operations is predefined. For example, a clock frequency falling within the range from 10 MHz to 50 MHz, for example, guarantees proper operations. In such a case, if the clock frequency is accidentally set to 100 MHz, the resource circuits end up operating outside the guaranteed range, resulting in the semiconductor chip being at the risk of going out of control. A further example may be an A/D converter in which proper conversion speed is 1-mega samplings per second. If the conversion speed is set to 10-mega samplings, proper A/D conversion cannot be attained.

As a technology for prohibiting an incorrect setting to a register, Patent Document 1 provides a key data register to which the same address as that of a set register is assigned. An unlocking instruction signal is generated only when the same data as predetermined data is written to the key data register, making it possible to write to the set register. This removes ease with which writing is done to the set register, thereby preventing accidental writing to the set register.

[Patent Document 1] Japanese Patent Application Publication No. 2003-150448

The construction disclosed in Patent Document 1 requires that an unlocking process be performed by following predetermined procedures at the time of writing to the register. This results in complicated control procedures. Also, the processing time required for the unlocking process cannot be ignored if rewriting to the register is frequently performed. Further, if the user intends to set the register, but attempts to write a prohibited set value by mistake, the writing of such prohibited set value is accepted through the unlocking process as if there was no problem. Namely, the value of the key data register serving as a key is checked, but the set value to be written to the register is not checked. That is, no proper prevention is given in the case where an attempt is made to write an incorrect set value.

Accordingly, there is a need for a semiconductor device which can reliably prevent a prohibited set value from being written to a register.

### SUMMARY OF THE INVENTION

It is a general object of the present invention to provide a semiconductor device that substantially obviates one or more problems caused by the limitations and disadvantages of the related art.

Features and advantages of the present invention will be presented in the description which follows, and in part will become apparent from the description and the accompanying drawings, or may be learned by practice of the invention according to the teachings provided in the description. Objects as well as other features and advantages of the present invention will be realized and attained by a semiconductor device particularly pointed out in the specification in such full, clear, concise, and exact terms as to enable a person having ordinary skill in the art to practice the invention.

To achieve these and other advantages in accordance with the purpose of the invention, the invention provides a semiconductor device which includes a data hold circuit configured to acquire data from a data bus and hold the data therein in response to assertion of a write signal, a prohibited set value hold circuit configured to store a predetermined prohibited set value, and a comparison circuit coupled to the data hold circuit and the prohibited set value hold circuit, and configured to assert a prohibition signal in response to a match between the prohibited set value stored in the prohibited set value hold circuit and the data held in the data hold circuit, the assertion of the prohibition signal preventing the data from being written to a predetermined register.

According to another aspect of the present invention, a method of controlling writing of data to a register includes the steps of transmitting the data to a data bus so as to write the data to the register, monitoring the data bus by comparing the data appearing on the data bus with a prohibited set value defined for the register, and prohibiting the writing of the data to the register in response to detection of a match by said comparing between the data and the prohibited set value.

According to at least one embodiment of the invention, the write data is compared with the prohibited set value, and the prohibition signal is asserted in response to the match therebetween. Provision is further made such that the assertion of the prohibition signal prohibits the data from being written to the predetermined register. This can prevent the writing of a predetermined prohibited set value from being performed with respect to the predetermined register.

### BRIEF DESCRIPTION OF THE DRAWINGS

Other objects and further features of the present invention will be apparent from the following detailed description when read in conjunction with the accompanying drawings; in which

FIG. 1 is a block diagram showing the configuration of a semiconductor device according to the present invention;

FIG. 2 is a block diagram showing an example of the construction of a monitor circuit shown in FIG. 1;

FIG. 3 is a circuit diagram showing an example of the circuit construction of a comparison circuit;

FIG. 4 is a block diagram showing an address information hold circuit and a data information hold circuit;

FIG. 5 is a block diagram showing an example of the construction of the data information hold circuit;

FIG. 6 is a block diagram showing an example of the construction of an embodiment of a prohibited set value storage circuit; and

FIG. 7 is a block diagram showing the construction of a variation of the embodiment of the monitor circuit.

### DESCRIPTION OF THE PREFERRED EMBODIMENTS

In the following, embodiments of the present invention will be described with reference to the accompanying drawings.

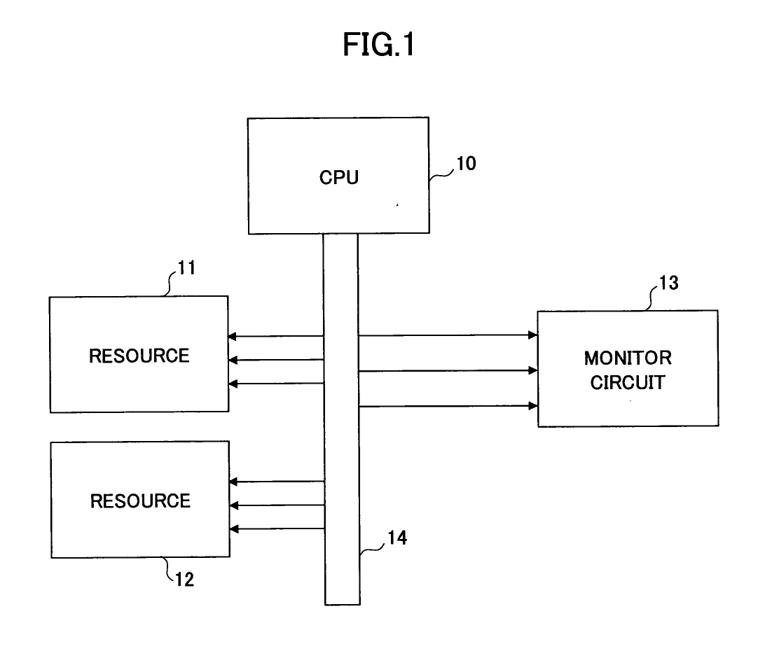

FIG. 1 is a block diagram showing the configuration of a semiconductor device according to the present invention. The semiconductor device of FIG. 1 includes a CPU 10, a resource 11, a resource 12, a monitor circuit 13, and a bus 14. The CPU 10, the resource 11, the resource 12, and the monitor circuit 13 are coupled to one another via the bus 14 inclusive of an address bus and a data bus. The bus 14 further includes a control bus for transmitting a write signal, a read signal, a reset signal, etc. The resource 11 and the resource 12 are provided with registers for the purpose of setting operation modes or the like. The monitor circuit 13 monitors a write signal, an address signal, and a data signal on the bus 14, thereby detecting the writing of a predetermined prohibited set value to a register having a predetermined assigned address.

The registers subject to the monitoring are not limited to the registers provided in the resource 11 or the resource 12. If another bus master is capable of writing to a register inside the CPU 10, such a register of the CPU 10 may also be subject to the monitoring. Namely, when data is written to a predetermined address by a write signal, an address signal, and a data signal through the bus 14 in the semiconductor device of FIG. 1, any register to which the data is written maybe subject to monitoring by the monitor circuit 13.

The monitor circuit 13 asserts a reset signal in response to the detection of writing of a predetermined prohibited set value to the register having a predetermined address. In response to the assertion of the reset signal, all the circuits of the semiconductor device of FIG. 1 are reset. With this provision, it is possible to prevent the writing of the predetermined prohibited set value to the register having the predetermined address.

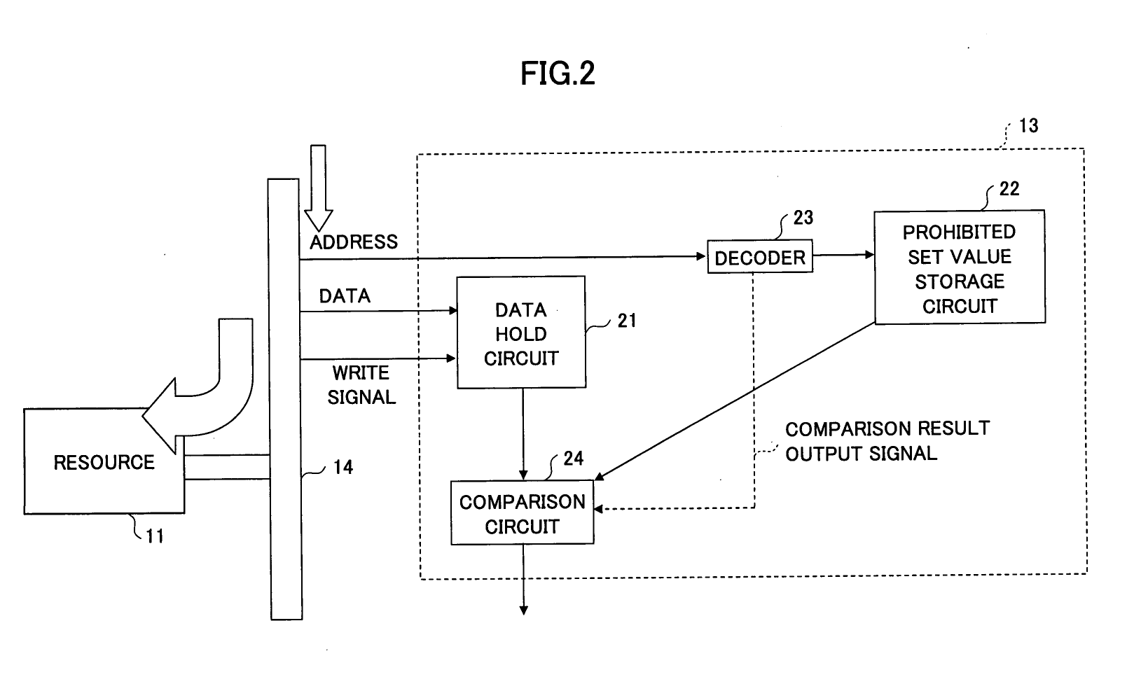

FIG. 2 is a block diagram showing an example of the construction of the monitor circuit 13. In FIG. 2, the monitor circuit 13 includes a data hold circuit 21, a prohibited set value storage circuit 22, a decoder 23, and a comparison circuit 24. The data hold circuit 21 acquires data on the data bus of the bus 14 for storage in a built-in register in response to the assertion of a write signal of the bus 14. The stored data is supplied to the comparison circuit 24. This data is write data that is to be written to any given register in the semiconductor device regardless of the address of this register.

The decoder 23 decodes an address signal on the address bus of the bus 14. When the address signal matches the address of a register subject to monitoring, the decoder 23 asserts a read signal to the prohibited set value storage circuit 22, and asserts a comparison result output signal to the comparison circuit 24.

The prohibited set value storage circuit 22 includes a register that stores a prohibited set value of the register subject to the monitoring. Upon the assertion of the read signal supplied from the decoder 23, the prohibited set value storage circuit 22 supplies the prohibited set value stored in the built-in register to the comparison circuit 24.

The comparison circuit 24 compares the write data supplied from the data hold circuit 21 with the prohibited set value supplied from the prohibited set value storage circuit 22. If the write data and the prohibited set value are identical, and if the comparison result output signal supplied from the decoder 23 is asserted, the comparison circuit 24 asserts a reset signal serving as its output. In response to the assertion of the reset signal, all the circuits in the semiconductor device of FIG. 1 are reset. With this provision, it is possible to prevent the writing of the predetermined prohibited set value to the register having the predetermined address.

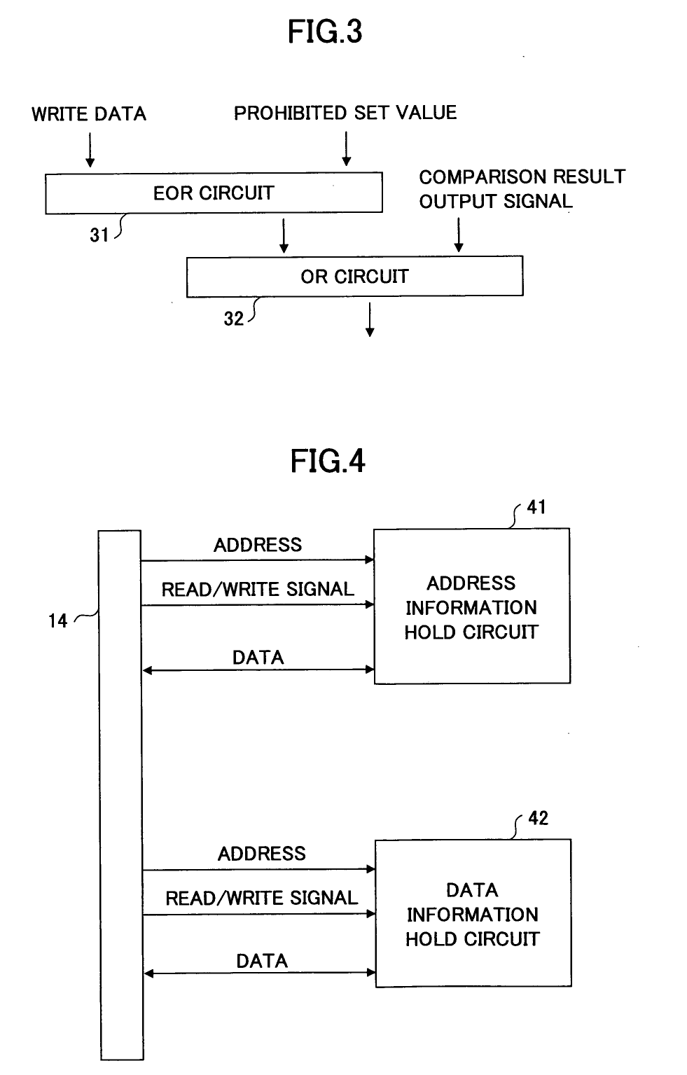

FIG. 3 is a circuit diagram showing an example of the circuit construction of the comparison circuit 24. The comparison circuit 24 of FIG. 3 includes an EOR circuit 31 and an OR circuit 32. The EOR circuit 31 obtains exclusive logical sums on a bit-by-bit basis between the write data supplied from the data hold circuit 21 and the prohibited set value supplied from the prohibited set value storage circuit 22, and supplies the results to the OR circuit 32. The results of exclusive logical sum becomes HIGH at the bit positions where the write data and the prohibited set value are different, and becomes LOW at the bit positions where they are the same. Namely, if the write data and the prohibited set value are completely identical, all the bits of the results of exclusive logical sum are LOW.

The OR circuit 32 obtains a logical sum between all the bits of the results of exclusive logical sum and the comparison result output signal supplied from the decoder 23. The comparison result output signal is a negative logic signal that assumes a LOW level in the asserted state, and becomes LOW when the write address and the address subject to monitoring are identical. The OR circuit 32 thus outputs a LOW reset signal only if the write data and the prohibited set value are completely identical and if the write address and the address subject to the monitoring are identical. This reset signal is a negative logic signal that assumes a LOW level in the asserted state. In response to the LOW output, the resetting of each circuit is performed.

The output of the prohibited set value storage circuit 22 always assumes some value. If this value and the write data coincide with each other by accident, the EOR circuit 31 ends up producing the same output as when the write data and the prohibited set value are completely identical. In order to prevent the reset signal from being asserted in such a case, therefore, provision such as the OR circuit 32 of FIG. 3 is preferably made to control whether to output the result of comparison by use of the comparison result output signal.

With the provision described in the above embodiment, it is possible to reset all the circuits in the semiconductor device by use of the reset signal if the writing of a predetermined prohibited set value is performed to the register having a predetermined address, thereby preventing the writing of the predetermined prohibited set value to the register having the predetermined address. In the construction of FIG. 2 described above, however, no function is provided to read the data contents of the data hold circuit 21. It is thus not possible to check the write data value that has caused the resetting. Further, no function is provided to record the address that has caused the resetting. It is thus not possible to identify the write-destination register that has caused the resetting. Because of this, sufficient information is not left for use in analysis to trace the cause of the resetting after the reset operation is performed. In consideration of this, it is preferable to provide such function that the address value and the write data value causing resetting are stored in the monitor circuit 13 for subsequent retrieval.

FIG. 4 is a block diagram showing an address information hold circuit and a data information hold circuit. An address information hold circuit 41 and a data information hold circuit 42 of FIG. 4 serve to store the address value and the write data value that cause resetting, respectively. Provision of the address information hold circuits 41 and the data information hold circuit 42 in the monitor circuit 13 of FIG. 2 makes it possible to use these data for the analysis to trace the cause of resetting. It should be noted, here, that the data information hold circuit 42 may be provided to replace the data hold circuit 21.

The address information hold circuit 41 acquires an address signal on the address bus of the bus 14 for storage in a built-in register in response to the assertion of a write signal. The data information hold circuit 42 acquires a data signal on the data bus of the bus 14 for storage in a built-in register in response to the assertion of a write signal. When the operation of the monitor circuits 13 as described above detects the writing of a predetermined prohibited set value to the register having a predetermined address, each circuit of the semiconductor device is reset. The built-in registers of the address information hold circuit 41 and the data information hold circuit 42 are configured such that they are not initialized by this resetting operation.

After the resetting, an address signal on the address bus of the bus 14 is set to select the address assigned to the address information hold circuit 41, with assertion of a read signal. This makes it possible to read the data contents of the address information hold circuit 41 (i.e., to read the address value that has caused the resetting). By the sake token, an address signal on the address bus of the bus 14 is set to select the address assigned to the data information hold circuit 42, with assertion of a read signal. This makes it possible to read the data contents of the data information hold circuit 42 (i.e., to read the write data value that has caused the resetting). Here, the address assigned to the data information hold circuit 42 needs to be different from addresses assigned to other registers provided in the semiconductor device. If the same address is assigned, data collision occurs at the time of data reading. The same applies in the case of the address information hold circuit 41.

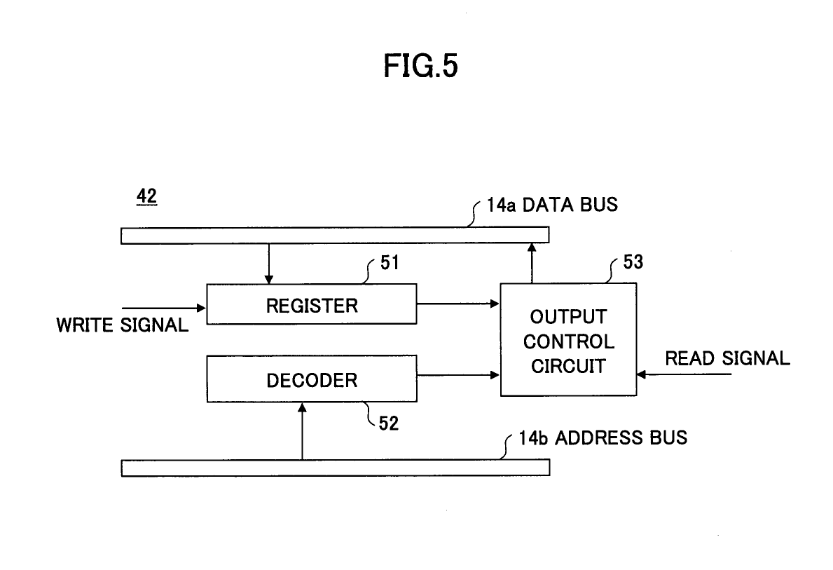

FIG. 5 is a block diagram showing an example of the construction of the data information hold circuit 42. The data information hold circuit 42 of FIG. 5 includes a register 51, a decoder 52, and an output control circuit 53. The register 51 is connected to a data bus 14a of the bus 14. The decoder 52 is connected to an address bus 14b of the bus 14. The register 51 acquires and stores data appearing on the data bus 14a of the bus 14 in response to the assertion of a write signal. The decoder 52 decodes an address signal supplied from the address bus 14b of the bus 14, and asserts a signal to the output control circuit 53 if this address signal matches the address assigned to the data information hold circuit 42. If the signal supplied from the decoder 52 and the read signal are both asserted, the output control circuit 53 outputs the contents of the register 51 to the data bus 14a. The output of the register 51 is not only connected to the input of the output control circuit 53, but also connected directly to the comparison circuit 24 of FIG. 2.

The address information hold circuit 41 may be configured in the same manner as the data information hold circuit 42. In the case of the address information hold circuit 41, however, the stored content is an address signal, so that the register 51 of FIG. 5 should be connected to the address bus 14b rather than to the data bus 14a. With this configuration, an address signal indicative of a write destination rather than a write data value is stored in the register 51 when the write signal is asserted.

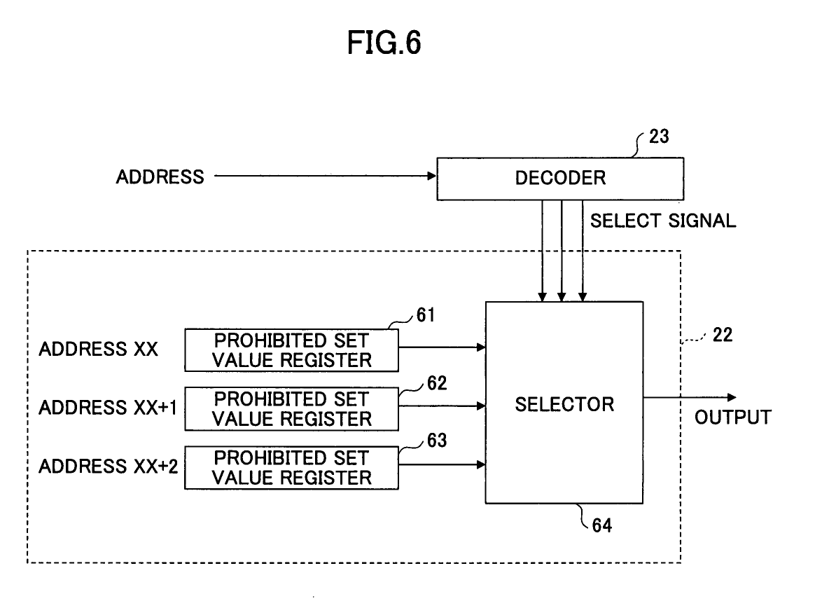

FIG. 6 is a block diagram showing an example of the construction of an embodiment of the prohibited set value storage circuit 22. The prohibited set value storage circuit 22 of FIG. 6 serves to store predetermined prohibited set values with respect to a plurality of registers, respectively.

The prohibited set value storage circuit 22 of FIG. 6 includes prohibited set value registers 61 through 63 and a selector 64. The prohibited set value registers 61 through 63 store a prohibited set value for a monitored register provided at the address XX, a prohibited set value for a monitored register provided at the address XX+1, and a prohibited set value for a monitored register provided at the address XX+2, respectively. Although the addresses are provided as consecutive addresses in this example, there is no need that these addresses are consecutive. That is, the addresses may as well be any addresses subject to monitoring.

The decoder 23 decodes an address signal on the address bus of the bus 14 (FIG. 2). If the address signal matches any one of the addresses (XX, XX+1, XX+2) of the registers subject to monitoring, the decoder 23 selectively asserts a read signal (select signal) corresponding to the specified address for provision to the selector 64. In response to the read signal selectively asserted, the selector 64 selects a corresponding one of the prohibited set values supplied from the prohibited set value registers 61 through 63. The prohibited set value that is selected for output is supplied to the comparison circuit 24 of FIG. 2.

In this manner, the prohibited set value storage circuit 22 shown in FIG. 6 is provided with a plurality of prohibited set value registers that correspond to respective registers subject to monitoring, and that store respective prohibited set values. With this provision, it is possible to monitor a plurality of registers having respective, different addresses simultaneously.

The prohibited set value storage circuit 22 having the configuration as described above, however, can only monitor a single prohibited set value per monitored register. The number of prohibited set values is not limited to one for one register subject to monitoring. Any one of the plurality of prohibited set values, if written, may cause malfunction. In some cases, thus, it is preferable to provide a configuration in which a plurality of prohibited set values can be monitored for each register subject to monitoring.

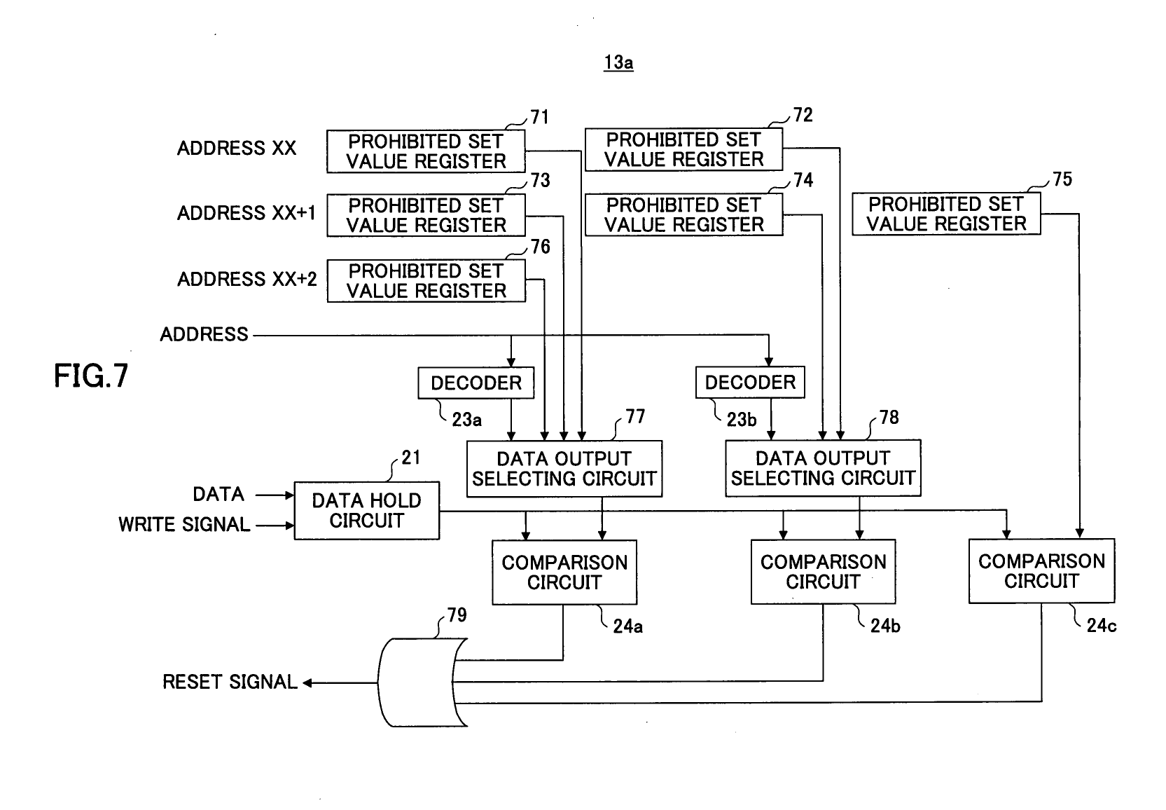

FIG. 7 is a block diagram showing the construction of a variation of the embodiment of the monitor circuit. A monitor circuit 13a of FIG. 7 is configured such that a plurality of prohibited set values can be monitored with respect to each register subject to monitoring. In FIG. 7, the same elements as those of FIG. 2 are referred to by the same numerals, and a description thereof will be omitted.

The monitor circuit 13a of FIG. 7 includes the data hold circuit 21, a decoder 23a, a decoder 23b, prohibited set value registers 71 through 76, a data output selecting circuit 77, a data output selecting circuit 78, comparison circuits 24a through 24c, and an OR circuit 79.

The data hold circuit 21 acquires data on the data bus for storage in a built-in register in response to the assertion of a write signal. The stored data is supplied to the comparison circuits 24a through 24c. This data is write data that is to be written to any given register in the semiconductor device regardless of the address of this register.

The prohibited set value registers 71 and 72 store two prohibited set values for the register subject to monitoring provided at the address XX. The prohibited set value registers 73, 74, and 75 store three prohibited set values for the register subject to monitoring provided at the address XX+1. The prohibited set value register 76 store one prohibited set value for the register subject to monitoring provided at the address XX+2. Although the addresses are provided as consecutive addresses in this example, there is no need that these addresses are consecutive. That is, the addresses may as well be any addresses subject to monitoring.

The decoders 23a and 23b decode an address signal on the address bus of the bus 14 (FIG. 2). If the address signal matches any one of the addresses (XX, XX+1, XX+2) of the registers subject to monitoring, the decoders 23a and 23b selectively assert a read signal (select signal) corresponding to the specified address for provision to the data output selecting circuits 77 and 78, respectively. In response to the asserted read signal, the data output selecting circuit 77 selects and outputs a corresponding one of the three prohibited set values supplied from the prohibited set value registers 71, 73, and 76. In response to the asserted read signal, moreover, the data output selecting circuit 78 selects and outputs a corresponding one of the two prohibited set values supplied from the prohibited set value registers 72 and 74. The prohibited set values selectively output by the data output selecting circuits 77 and 78 are supplied to the comparison circuits 24a and 24b, respectively. The prohibited set value of the prohibited set value register 75 is supplied to the comparison circuit 24.

The comparison circuit 24a through 24c compares the write data supplied from the data hold circuit 21 with the prohibited set values supplied from the corresponding prohibited set value registers. If the write data and any one of the prohibited set values are identical, the comparison circuits 24a through 24c assert the reset signals serving as their outputs. These reset signals are positive logic signals. The OR circuit 79 obtains a logical sum between the reset signals supplied from the comparison circuits 24a through 24c. This provides for the reset signal output from the OR circuit 79 to be asserted if writing is performed with respect to any one of the one or more prohibited set values provided for any one of the registers subject for monitoring. In response to the assertion of this reset signal, all the circuits in the semiconductor device of FIG. 1 are reset. With this provision, it is possible to monitor one or more prohibited set values for each of the plurality of registers subject to monitoring, thereby preventing any prohibited set value from being written in a register subject to monitoring.

In the configuration of FIG. 7, the comparison result output signal as used in FIG. 2 may be used to control the outputting of the comparison result. Such configuration can prevent a reset signal from being asserted in response to an accidental match.

Further, the present invention is not limited to these embodiments, but various variations and modifications may be made without departing from the scope of the present invention.

The above embodiments have been described with respect to a configuration in which a reset signal is generated in response to the detection of the writing of a prohibited set value to a register subject to monitoring. Alternatively, a mask signal may be generated in place of the reset signal, and this mask signal may be used to prevent writing to a register subject to monitoring. In this case, a conventional configuration would results in data being written to a register subject to monitoring once a write signal is asserted with the write data signal and the address signal indicative of the write destination being supplied to the bus. To prevent this, the register subject to monitoring may be configured to latch the data at delayed timing. Provision is then made such that the register latches the data if the mask signal is not asserted, and refrains from latching the data if the mask signal is asserted.

What is claimed is:

1. A semiconductor device, comprising:
a data hold circuit configured to acquire data from a data bus and hold the data therein in response to assertion of a write signal;
a prohibited set value hold circuit configured to store a predetermined prohibited set value; and
a comparison circuit coupled to said data hold circuit and said prohibited set value hold circuit, and configured to assert a prohibition signal in response to a match between the prohibited set value stored in said prohibited set value hold circuit and the data held in said data hold circuit, the assertion of the prohibition signal preventing the data from being written to a predetermined register.

2. The semiconductor device as claimed in claim 1, wherein the prohibition signal is a reset signal that resets the semiconductor device.

3. The semiconductor device as claimed in claim 1, wherein said prohibited set value hold circuit supplies the prohibited set value to said comparison circuit in response to a match between an address appearing on an address bus and an address of said predetermined register.

4. The semiconductor device as claimed in claim 1, wherein said comparison circuit asserts the prohibition signal in response to the match between the prohibited set value and the data if accompanied by a match between an address appearing on an address bus and an address of said predetermined register.

5. The semiconductor device as claimed in claim 1, wherein said data hold circuit has a predetermined address assigned thereto, said data hold circuit outputting the data held therein to the data bus in response to appearing of the predetermined address on an address bus accompanied by assertion of a read signal.

6. The semiconductor device as claimed in claim 1, further comprising an address information hold circuit configured to acquire an address from an address bus and hold the address therein in response to the assertion of the write signal, and configured to output the address held therein to the data bus in response to appearing of a predetermined address on the address bus accompanied by assertion of a read signal.

7. The semiconductor device as claimed in claim 1, wherein said prohibited set value hold circuit includes:
a plurality of prohibited set value registers to store respective prohibited set values; and
a data output selecting circuit configured to select one of the prohibited set values stored in said prohibited set value registers in response to an address appearing on an address bus to supply the selected one to said comparison circuit.

8. The semiconductor device as claimed in claim 1, wherein said prohibited set value hold circuit includes:
a plurality of prohibited set value registers to store respective prohibited set values; and
a data output selecting circuit configured to select at least two of the prohibited set values stored in said prohibited set value registers in response to an address appearing on an address bus to supply said at least two of the prohibited set values to said comparison circuit,
wherein said comparison circuit asserts the prohibition signal in response to a match between one of said at least two of the prohibited set values and the data held in said data hold circuit.

9. A method of controlling writing of data to a register, comprising the steps of:
transmitting the data to a data bus so as to write the data to the register;
monitoring the data bus by comparing the data appearing on the data bus with a prohibited set value defined for the register; and
prohibiting the writing of the data to the register in response to detection of a match by said comparing between the data and the prohibited set value.

10. The method as claimed in claim 9, wherein said step of prohibiting the writing of the data comprises a step of resetting a circuit inclusive of the register.
